(19) United States
(12) Patent Application Publication
(10) Pub. No.: US 2015/0067410 A1
(43) Pub. Date: Mar. 5, 2015

(54) HARDWARE FAILURE PREDICTION SYSTEM

(71) Applicant: TATA CONSULTANCY SERVICES LIMITED, Mumbai (IN)

(72) Inventors: Rohit KUMAR, Bangalore (IN); Senthilkumar VIJAYAKUMAR, Bangalore (IN); Syed Azar AHAMED, Bangalore (IN)

(73) Assignee: TATA CONSULTANCY SERVICES LIMITED, Mumbai (IN)

(21) Appl. No.: 14/144,823

(22) Filed: Dec. 31, 2013

(30) Foreign Application Priority Data
Aug. 27, 2013 (IN) 2794/MUM/2013

(51) Int. Cl. G06F 11/00

(52) U.S. Cl. CPC G06F 11/004
USPC 714/47.3

(57) ABSTRACT

The present subject matter discloses a method for predicting failure of hardware components. The method comprises obtaining a syslog file stored in a Hadoop Distributed File System (HDFS), where the syslog file includes at least one or more syslog messages. Further, the method comprises categorizing each of the one or more syslog messages into one or more groups based on a hardware component generating the syslog message. Further, a current dataset comprising one or more records based on the categorization is generated, where each of the one or more records include a syslog message from amongst the one or more syslog messages. The method further comprises analysing the current dataset for identifying at least one error pattern of syslog messages, based on a plurality of error patterns of reference syslog messages, for predicting failure of the hardware components.

### TECHNICAL FIELD

The present subject matter relates, in general, to failure prediction and, in particular, to predicting failure in hardware components.

### BACKGROUND

Service providers nowadays offer a well knit information technology (IT) network to organizations, such as business enterprises, educational institutions, web organizations, and management firms, for implementing various applications and managing data. Such IT networks typically include several hardware components, for example, servers, processors, boards, hubs, switches, routers, and hard disks, interconnected with each other. The IT network provides support for running applications, processes, and storage and retrieval of data from a centralized location. In routine course of operation, such hardware components encounter sudden failures for varied reasons, such as improper maintenance, overheating, electrostatic discharge, and the like, and thus may lead to disruption in operation of the organization, resulting in losses for the organization.

### BRIEF DESCRIPTION OF THE DRAWINGS

The detailed description is described with reference to the accompanying figure(s). In the figure(s), the left-most digit(s) of a reference number identifies the figure in which the reference number first appears. The same numbers are used throughout the figure(s) to reference like features and components. Some embodiments of systems and/or methods in accordance with embodiments of the present subject matter are now described, by way of example only, and with reference to the accompanying figure(s), in which:

FIG. 1 illustrates a network environment implementing a hardware failure prediction system, according to an embodiment of the present subject matter;

FIG. 2 illustrates components of a hardware failure prediction system for predicting failures in hardware components, according to an embodiment of the present subject matter;

FIG. 3 illustrates a method for generating training data for predicting failure in hardware components, according to an embodiment of the present subject matter; and

FIG. 4, illustrates a method for predicting failure of hardware components, according to an embodiment of the present subject matter.

### DETAILED DESCRIPTION

IT networks are typically deployed by organizations, such as banks, educational institutions, private sector companies, and business enterprises for management of applications and data. The IT network may be understood as IT infrastructure comprising several hardware components, such as servers, processors, routers, hubs, and storage devices, like hard disks, interconnected with each other. Such hardware components may encounter sudden failure during their operation due to several reasons, such as improper maintenance, manufacturing defects, expiry of lifecycle, over heating, electrical faults leading to component damage, and so on. Sudden failure of a hardware component may affect the overall operation supported by the IT network. For instance, failure of a server that supports an organization's database application may result in the data becoming in accessible. Further, identification and replacement of the failed hardware component may take time and may impede proper functioning of several applications that rely on that hardware component. Additionally, the cost of replacing the hardware component results in monetary losses for the service provider.

In a conventional technique, Self-Monitoring Analysis and Reporting Technology (SMART) messages generated by hard disks are analysed for predicting failures of hardware components of the IT network. Such SMART messages include information pertaining to hard disk events which may be analysed using a monitoring system based on Support Vector Machine (SVM) classification technique. However, monitoring of SMART messages for predicting hardware component failure limits the hardware components that may be monitored to hard disks only, thereby eliminating failure prediction of other hardware components, such as servers and processors. Further, the conventional technique may be implemented over a localized network only which may limit the prediction of failure to the localized network. Thus, in a case where several localized networks may be interconnected, each localized network may require implementation of the conventional technique separately, thereby increasing the implementation cost for the service provider. Moreover, the SVM technique implemented by the monitoring system requires high processing time and memory space, thereby resulting in greater computational overheads for predicting failure of the hardware components.

The present subject matter relates to systems and methods for predicting failure of hardware components in a network. In accordance with the present subject matter, a failure prediction system is disclosed. The failure prediction system may be implemented in a computing environment, for example, a cloud computing environment, for predicting failure of the hardware components, such as servers, hard disks, processors, routers, switches, hubs, boards, and the like.

As mentioned previously, the hardware components are generally implemented by an organization for running applications and management of data. The hardware components typically generate syslog messages including information pertaining to the processes and tasks performed by the hardware components. Such syslog messages are generally stored in a syslog file in a storage device. As will be understood, a plurality of syslog files may exist in the IT network.

According to an embodiment of the present subject matter, the failure prediction system predicts failure of the hardware components based on the syslog messages logged in the syslog file and training data stored in a parallel processing database, for example, a Greenplum™ database. The training data may be understood as data used for identifying error patterns of syslog messages in the syslog file and subsequently predicting failure of the hardware components based on the error patterns.

In order to generate the training data, initially a syslog file stored in a Hadoop Distributed File System (HDFS) may be accessed by a node of a Hadoop framework. In one implementation, the syslog file may include at least one or more syslog messages, where each of the one or more syslog messages include information pertaining to a plurality of fields. In one example, the information may pertain to the operations and tasks performed by the hardware component generating the syslog message. For instance, the syslog message may include information, such as a slot number of a server generating the syslog message and the same may be recorded in a slot field in the syslog file. The information included in each of the one or more syslog messages may be analysed by the node for generating the training data for predicting failure in hardware components.

For this, upon accessing the syslog file, each of the one or more syslog messages may be categorized into one or more groups by the node, based on the component generating the syslog message. For instance, a syslog message generated by a server may be categorized into a serverOS group. Thereafter, the node may generate a dataset, interchangeably referred to as training dataset, comprising one or more records based on the categorization, where each of the one or more records includes a syslog message from amongst the one or more syslog messages. The training dataset thus generated may be used for analysing the information stored in the syslog messages and subsequently identifying the error patterns of syslog messages. The node may store the dataset locally or with the HDFS.

In one implementation, a failure prediction device of failure prediction system may analyse the training dataset using Parallel Support Vector Machine (PSVM) classification technique for identifying a sequence of syslog messages based on instances of predetermined critical terms, such that each of the syslog messages in the sequence of syslog messages includes one or more of the predetermined critical terms. Thereafter, the sequence of messages may be labelled as one of an error pattern of reference syslog messages and a non-error pattern of reference syslog messages. An error pattern of reference syslog messages may be understood as a sequence of syslog messages which may result in a failure of the hardware component. A non-error pattern of reference syslog messages may be understood as a sequence of syslog messages which do not result in a failure of the hardware component. As will be understood, a plurality of error patterns of reference syslog messages may be identified which may be used for predicting failure of the hardware components. In one implementation, error resolution data may be associated with each of the plurality of error patterns of reference syslog messages. Error resolution data includes the steps which may be performed by a user, such as an administrator, for resolving the probable failure of the hardware components. Thereafter, the error patterns and the error resolution data associated with each of the error patterns of reference syslog messages may be stored as training data in a parallel processing database. The use of the PSVM classification technique reduces the computational time required for generating the training data and thus results in better utilization of system resources.

The training data thus generated may then be used by the failure prediction system for predicting failure of the hardware components in the IT network, for example, in real-time. For the purpose, the node may initially access a current syslog file and subsequently generate a dataset, interchangeably referred to as current dataset, in a manner as described above. A current syslog file may be understood as a syslog file which is accessed by the node in real-time. Thereafter, the failure prediction device may analyse the current dataset for identifying at least one error pattern of syslog messages based on the plurality of error patterns of reference syslog messages stored in the parallel processing database. In one implementation, upon identification of the at least one pattern, the failure prediction system may provide the error resolution data associated with the at least pattern of reference syslog messages to the user.

Thus, the present subject matter discloses an efficient failure prediction system for predicting failure of the hardware components based on syslog messages. The failure prediction system disclosed herein may be implemented in a cloud computing environment, thereby improving the scalability of the failure prediction system and averting the need for implementing separate failure prediction system for a set of localized systems. Further, implementation of the HDFS ensures scalability and efficient storage of large sized syslog files. As will be clear from the foregoing description, implementation of the parallel processing database for storing the training data enables fast storage and retrieval of the training data for being used in the prediction of failure of the hardware components, thereby reducing the computational time for the process and resulting in failure prediction in less time.

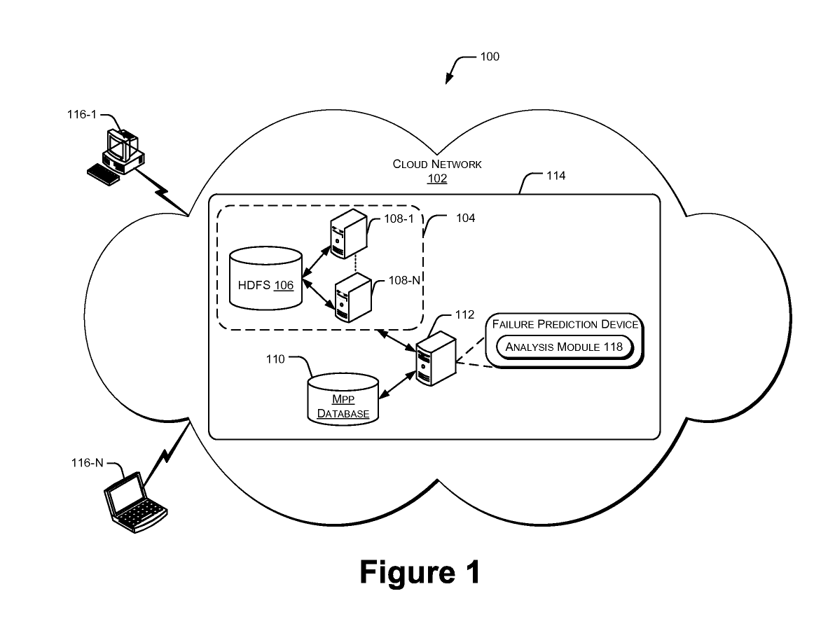

These and other advantages of the present subject matter would be described in greater detail in conjunction with the following FIGS. 1-4. While aspects of described systems and methods can be implemented in any number of different computing systems, environments, and/or configurations, the embodiments are described in the context of the following exemplary system(s).

FIG. 1 illustrates a network environment 100, in accordance with an embodiment of the present subject matter. In one implementation, the network environment 100 includes a network, such as Cloud network 102, implemented using any known Cloud platform, such as OpenStack. In another implementation, the network environment may include any other IT infrastructure network.

In one implementation, the Cloud network 102 may host a Hadoop framework 104 comprising a Hadoop Distributed File System (HDFS) 106 and a cluster of system nodes 108-1, . . . , 108-N, interchangeably referred to as nodes 108-1 to 108-N. Further, the cloud network 102 includes a Massive Parallel Processing (MPP) database 110. In one example, the MPP database 110 has a shared nothing architecture in which data is partitioned across multiple segment servers, and each segment owns and manages a distinct portion of the overall data. As will be understood, Shared-nothing-architecture provides every segment with an independent high-bandwidth connection to a dedicated storage. Further, the MPP database 110 may implement various technologies, such as parallel query optimization and parallel dataflow engine. Example of such MPP database 110 includes, but is not limited to, a Greenplum® database built upon PostgreSQL open-source technology.

The cloud network 102 further includes a failure prediction device 112 in accordance with the present subject matter. Examples of the failure prediction device 112 may include, but are not limited to, a server, a workstation computer, a desktop computer, and the like. The Hadoop framework 104 comprising the HDFS 106 and nodes 108-1 to 108-N, the MPP database 110, and the failure prediction device 112 may be communicating with each other over the cloud network 102 and may be collectively referred to as a failure prediction system 114 for predicting failure of hardware components in accordance with an embodiment of the present subject matter.

Further, the network environment 100 includes user devices 116-1, . . . , 116-N, which may communicate with each other through the cloud network 102. The user devices 116-1, . . . , 116-N may be collectively referred to as the user devices 116 and individually referred to as the user device 116. Examples of the user devices 116 include, but are not restricted to, desktop computers, laptops, smart phones, personal digital assistants (PDAs), tablets, and the like.

In an implementation, the user devices 116 may perform several operations and tasks over the cloud network 102. Execution of such operations and tasks may involve computations and storage activities performed by several hardware components, such as processors, servers, hard disks, and the like, present in the cloud network 102, not shown in figure for the sake of brevity. The hardware components typically generate a syslog message including information pertaining to each and every operation and task performed by the hardware component. Such syslog messages are generally logged in a syslog file which may be stored in the HDFS 106 of the Hadoop framework 104.

According to an embodiment of the present subject matter, the failure prediction system 114 may predict failure of the hardware components based on the syslog file and training data. The training data may be understood as data generated by the failure prediction device 112 using reference syslog messages during a machine learning-training phase for predicting the failure of the hardware components. In one implementation, the training data may include a plurality of error patterns of reference syslog messages identified by the failure prediction device 112 during the machine learning-training phase.

During the machine learning-training phase, the node 108-1 may initially generate a dataset based on the syslog file stored in the HDFS 106. For the purpose, the node 108-1 may access the syslog file stored in the HDFS 108. In an implementation, the syslog file may include at lease one or more syslog messages having information corresponding to a plurality of fields. Examples of the fields may include, but are not limited to, date and time, component, facility, message type, slot, message, and description. For instance, a syslog message, amongst other information, may include a slot ID “s1”, i.e., the information pertaining to the slot field.

Upon obtaining the syslog file, the node 108-1 may categorize the one or more syslog messages into one or more different groups based on a hardware component generating the syslog message. For instance, the node 108-1 may categorize a syslog message generated by a server into a serverOS group. In one example, the node 108-1 may categorize each of the one or more messages into at least one of a serverOS group, platform group, and core group.

Thereafter, the node 108-1 may generate a dataset comprising one or more records, where each of the one or more records includes data pertaining to a syslog message from amongst the one or more syslog messages. As will be understood, the data may pertain to the plurality of fields and may be separated by a delimiter, for example, a comma. In one example, the dataset may be generated using known folding window technique and may include 5 records, where each record may be obtained in a manner as explained above. In another example, the dataset may be generated using known sliding technique and may include 5 records, where each record may be obtained in a manner as explained above. The dataset, interchangeably referred to as dataset window or training dataset, thus generated may then be used for generating the training data.

In an implementation, the failure prediction device 112 may generate the training data based on the training dataset using a Parallel Support Vector Machine (PSVM) classification technique. For the purpose, the failure prediction device 112 may initially identify a sequence of syslog messages, included in the training dataset, based on instances of predetermined critical terms such that each of the syslog messages in the sequence of syslog messages includes one or more of the predetermined critical terms. Examples of the predetermined critical terms may include, but are not limited to, alert, warning, error, abort, and failure. In one example, the failure prediction device 112 may identify instances of the critical terms in a predetermined interval of time for determining the sequence of syslog messages.

Upon identifying the sequence of syslog messages, the failure prediction device 112 may ascertain whether the sequence of syslog messages may result in a failure, in future, of the hardware component generating the syslog messages or not. In one example, the failure prediction device 112 may use predetermined error data for the ascertaining. The predetermined error data may be understood as data based on occurrences of past hardware failure events. In another implementation, a user, such as an administrator or expert may perform the ascertaining.

Upon ascertaining the sequence of syslog messages, the failure prediction device 112 may label each of the sequence of syslog messages as wither one of an error pattern of reference syslog messages and a non-error pattern of reference syslog messages. The labelling of the sequence of syslog messages may also be referred to as machine learning-training phase. In one implementation, a user, for example, an administrator may perform the labelling of the sequence of syslog messages based on the predetermined error data. In a case where it is ascertained that the sequence of syslog messages has led to a failure of the hardware component in the past, the sequence of messages may be labelled as an error pattern of reference syslog messages. On the other hand, in a case where the sequence of messages did not result in a failure of the hardware component in the past, the sequence of syslog messages may be labelled as non-error pattern of reference syslog messages.

Further, in one implementation, an error resolution data may be associated with each of the error pattern of reference syslog messages identified above. The error resolution data may be understood as steps that may be performed for averting the failure of the hardware component. In one example, a user, such as an administrator may associate the error resolution data with the error pattern of reference syslog messages. Thereafter, the error pattern of reference syslog messages and the error resolution data associated with each of the error pattern of reference syslog messages may be stored as training data in the MPP database 110. The training data may then be used for predicting failure of the hardware components in future.

In one implementation, the labelled sequence of syslog messages, i.e., the error pattern of reference syslog messages and the non-error pattern of reference syslog messages may be analysed by the failure prediction device 112 using the Parallel Support Vector Machine (PSVM) classification technique. Based on the analysis, the failure prediction device 112 may update the training data which is used for predicting failure of hardware components. As will be understood, the PSVM classification technique may be implemented as a workflow using data analytics tools and helps in developing the training data based on which the failure prediction device 112 predicts the failure of hardware components.

In one implementation, before generating the training data, a small segment of the training dataset may be stored as validation dataset. In one example, the segment of the dataset to be stored as validation dataset may be determined based on a predetermined percentage specified in the failure prediction device 112. In another example, the segment of the training dataset to be stored as validation data may be determined based on a user input. The validation dataset may then be used later, upon generation of the training data, for testing the accuracy of the failure prediction device 112. The validation dataset may be stored in the MPP database 110. The said implementation may also be referred to machine learning-evaluation phase.

During the machine learning-evaluation phase, the validation dataset may be provided to the failure prediction device 112 for predicting failure of the hardware components based on the training data. Subsequently, the result of the machine learning-evaluation phase may be evaluated by the administrator for determining the accuracy of the failure prediction device 112. In one example, the result of the machine learning-evaluation phase may be used for updating the training data. The training data thus generated may be used for predicting failure of the hardware components.

The prediction of failure of the hardware components in the cloud network 102 may also be referred to as the production phase. In operation, during the production phase, the node 108-1 may access a syslog file stored in the HDFS 106 and then subsequently generate a dataset, interchangeably referred to as current dataset, based on the syslog file in a manner as described earlier. The current dataset thus generated may then be analysed by the failure prediction device 112 for predicting failure of the hardware components. For the purpose, the failure prediction device 112 may include an analysis module 118.

In one implementation, the analysis module 118 may process the syslog messages included in the current dataset for ascertaining whether a sequence of syslog messages corresponds to error patterns identified during the machine learning-training phase. For instance, the analysis module 118 may compare the sequence of syslog messages included in the current dataset with the plurality of error patterns of reference syslog messages for identifying the at least one error pattern of reference syslog messages. In a case, where the analysis module 118 ascertains that sequence of syslog messages matches the at least one error pattern of reference syslog messages, the failure prediction device 112 may subsequently provide the error resolution data associated with the error pattern to a user, such as an administrator.

Thus, the failure prediction system 114 implementing the Hadoop framework 104 and the MPP database 110 in the cloud network 102 provides an efficient, scalable, and efficient resource consuming system for predicting the failures of the hardware components present in the cloud network 102.

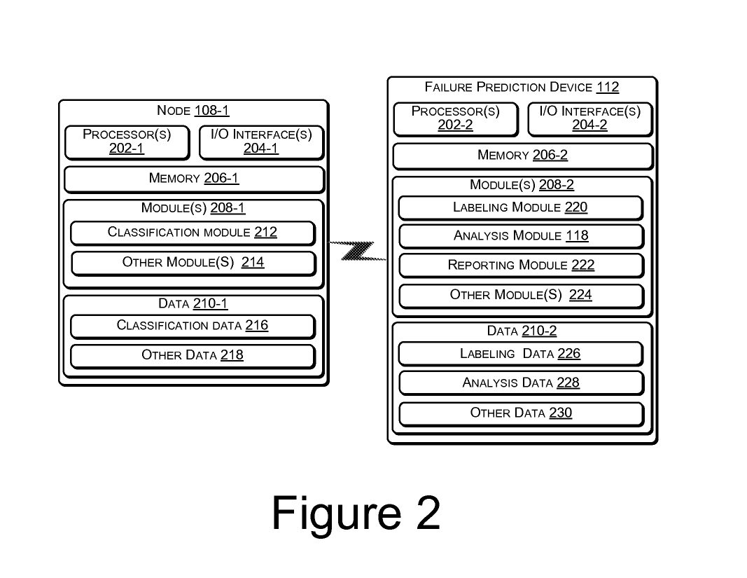

FIG. 2 illustrates the components of the node 108-1, and the components of the failure prediction device 112, according to an embodiment of the present subject matter. In accordance with the present subject matter, the node 108-1 and the failure prediction device 112 are communicatively coupled to each other through the various components of the cloud network 102 (as illustrated in FIG. 1).

The node 108-1 and the failure prediction device 112 include processors 202-1, 202-2, respectively, and collectively referred to as processor 202 hereinafter. The processor 202 may be implemented as one or more microprocessors, microcomputers, microcontrollers, digital signal processors, central processing units, state machines, logic circuitries, and/or any devices that manipulate signals based on operational instructions. Among other capabilities, the processor(s) is configured to fetch and execute computer-readable instructions stored in the memory.

The functions of the various elements shown in the figure, including any functional blocks labeled as “processor(s)”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), non-volatile storage. Other hardware, conventional and/or custom, may also be included.

Also, the node 108-1 and the failure prediction device 112 include I/O interface(s) 204-1, 204-2, respectively, collectively referred to as I/O interfaces 204. The I/O interfaces 204 may include a variety of software and hardware interfaces that allow the node 108-1 and the failure prediction device 112 to interact with the cloud network 102 and with each other. Further, the I/O interfaces 204 may enable the node 108-1 and the failure prediction device 112 to communicate with other communication and computing devices, such as web servers and external repositories.

The node 108-1 and the failure prediction device 112 may include memory 206-1, and 206-2, respectively, collectively referred to as memory 206. The memory 206-1 and 206-2 may be coupled to the processor 202-1, and the processor 202-2, respectively. The memory 206 may include any computer-readable medium known in the art including, for example, volatile memory (e.g., RAM), and/or non-volatile memory (e.g., EPROM, flash memory, etc.).

The node 108-1 and the failure prediction device 112 further include modules 208-1, 208-2, and data 210-1, 210-2, respectively, collectively referred to as modules 208 and data 210, respectively. The modules 208 include routines, programs, objects, components, data structures, and the like, which perform particular tasks or implement particular abstract data types. The modules 208 further include modules that supplement applications on the node 108-1 and the failure prediction device 112, for example, modules of an operating system.

Further, the modules 208 can be implemented in hardware, instructions executed by a processing unit, or by a combination thereof. The processing unit can comprise a computer, a processor, such as the processor 202, a state machine, a logic array or any other suitable devices capable of processing instructions. The processing unit can be a general-purpose processor which executes instructions to cause the general-purpose processor to perform the required tasks or, the processing unit can be dedicated to perform the required functions.

In another aspect of the present subject matter, the modules 208 may be machine-readable instructions (software) which, when executed by a processor/processing unit, perform any of the described functionalities. The machine-readable instructions may be stored on an electronic memory device, hard disk, optical disk or other machine-readable storage medium or non-transitory medium. In one implementation, the machine-readable instructions can be also be downloaded to the storage medium via a network connection. The data 210 serves, amongst other things, as a repository for storing data that may be fetched, processed, received, or generated by one or more of the modules 208.

In an implementation, the modules 208-1 of the node 108-1 include a classification module 212 and other module(s) 214. In said implementation, the data 210-1 of the node 108-1 includes classification data 216 and other data 218. The other module(s) 214 may include programs or coded instructions that supplement applications and functions, for example, programs in the operating system of the node 108-1, and the other data 218 comprise data corresponding to one or more other module(s) 214.

Similarly, in an implementation, the modules 208-2 of the failure prediction device 112 include a labelling module 220, an analysis module 118, a reporting module 222, and other module(s) 224. In said implementation, the data 210-2 of the failure prediction device 112 includes labelling data 226, analysis data 228, and other data 230. The other module(s) 224 may include programs or coded instructions that supplement applications and functions, for example, programs in the operating system of the failure prediction device 112, and the other data 230 comprise data corresponding to one or more other module(s) 224.

According to an implementation of the present subject matter, the classification module 212 of the node 108 may generate a dataset based on a syslog file for being used in generating a training data for predicting failure of hardware components. Examples of the hardware components may include, but are not limited to, processors, servers, hard disks, routers, switches, and hubs.

In order to generate the dataset, the classification module 212 may initially access the syslog file stored in a HDFS 106 (not shown in FIG. 2). The syslog file, as described earlier, includes one or more syslog messages and a plurality of fields. Upon obtaining the syslog file, the classification module 212 may then categorize the one or more syslog messages into one or more groups based on the hardware component generating the message. For example, the classification module 212 may group the one or more syslog messages into at least one of a serverOS group, a platform group, and a core group.

Upon categorizing the one or more syslog messages, the classification module 212 may generate a dataset comprising one or more records, where each of the records include data pertaining to the plurality of fields of a syslog message from amongst the one or more syslog messages. In one example, the classification module 212 may generate the dataset comprising 5 records using a known folding window technique. In another example, the classification module 212 may generate the dataset comprising 5 records using known sliding window technique. The dataset window, interchangeably referred to as training dataset, thus generated may be stored in the classification data 216 and may be used for generating training data.

Upon generation of the training dataset, the failure prediction device 112 may generate the training data by analysing the syslog messages included in the training dataset. For the purpose, the labelling module 220 may obtain the training dataset stored in the classification data 216. Upon obtaining the training dataset, the labelling module 220 may identify instances of critical terms included in the syslog messages. The critical terms may be understood as terms indicative of a probable failure of an operation or tasks for which the syslog message was created. Examples of the critical term may include, but are not limited to, alert, abort, failure, error, attention, and the like.

Based on the instances of the critical terms, the labelling module 220 may determine a sequence of the syslog messages. In one implementation, the labelling module 220 may determine the sequence of syslog messages by identifying the instances of the critical in a given time frame. For example, the labelling module 220 may analyse the syslog messages for identifying the instances of the critical terms occurring within a time frame of fifteen minutes.

Upon determining the sequence of syslog messages, the labelling module 220 may ascertain whether the sequence of messages will lead to a failure of any hardware component or not. In one implementation, the labelling module 220 may perform the ascertaining based on a predetermined error data stored in an MPP database 110. The predetermined error data may be understood as data pertaining to past failure of the hardware components and the syslog messages that may have been generated before the failure occurred. In another implementation, the labelling module 220 may perform the ascertaining based on a user input from a user, such as an expert or an administrator.

Thereafter, the labelling module 220 may label the sequence of syslog messages as either one of an error pattern of reference syslog messages and non-error pattern of reference syslog messages. In a case where the sequence of syslog messages may result in a failure of the hardware component, the labelling module 220 may label the sequence of messages as error pattern of reference syslog messages. In a case, where the sequence of syslog messages may not result in a failure of the hardware component, the labelling module 220 may label the sequence of messages as non-error pattern of reference syslog messages. Further, in one implementation, the labelling module 220 may associate an error resolution data with the error pattern of reference syslog messages in a manner as described earlier. The error pattern of reference syslog messages and the error resolution data associated with it may then be stored as training data in the MPP database 110 and may be used in future for predicting failure of the hardware components. The aforementioned process of generating the training data may also be referred to as machine learning-training phase.

In one implementation, a small segment of the training dataset may initially be segmented and may be stored as validation dataset in the labelling data 226. The labelling data 226 may then be used later, upon the generation of the training data, for analysing the performance of the failure prediction device 112 in a manner as described previously. The said implementation may also be referred to as machine learning-evaluation phase.

According to an implementation, the failure prediction device 112 may use the training data for predicting failure of the hardware components in a network environment, such as a cloud network. Predicting failure of the hardware components based a syslog file and the training data may also be referred to as Production phase.

During the Production phase, the node 108-1 may initially generate a dataset, interchangeably referred to as current dataset, based on the syslog file in a manner as described above. The classification module 212 then stores the current dataset in the classification data 216. which may be then be used for predicting failure of hardware components.

Thereafter, the analysis module 118 may access the current dataset stored in the classification data 216 for analysing the current dataset based on the training data for identifying at least one error pattern of reference syslog messages from amongst a plurality of error patterns of reference syslog messages stored in the MPP database 110. For the purpose, the analysis module 118 may obtain the training data stored in the classification data 216.

In order to analyse the current dataset, the analysis module 118 may initially determine a sequence of syslog messages based on the critical terms included in each of the syslog messages in a manner as described earlier. Thereafter, the analysis module 118 may compare the sequence of syslog messages with the plurality of error patterns of reference syslog messages stored in the training data. In a case, where the analysis module 118 identifies the at least one pattern of reference syslog messages, the analysis module 118 may obtain the error resolution data associated with the at least one pattern of reference syslog messages stored in the MPP database 110. The analysis module 118 may then store the at least one error pattern of reference syslog messages and the error resolution data associated with it in the analysis data 228 which may then be provided to the user by the reporting module 222.

In one implementation, the reporting module 222 may obtain the error resolution data stored in the analysis data 228 and provide the same to the user. In one example, the error resolution data may be provided as an error resolution report including details of the hardware component which may lead to probable failure.

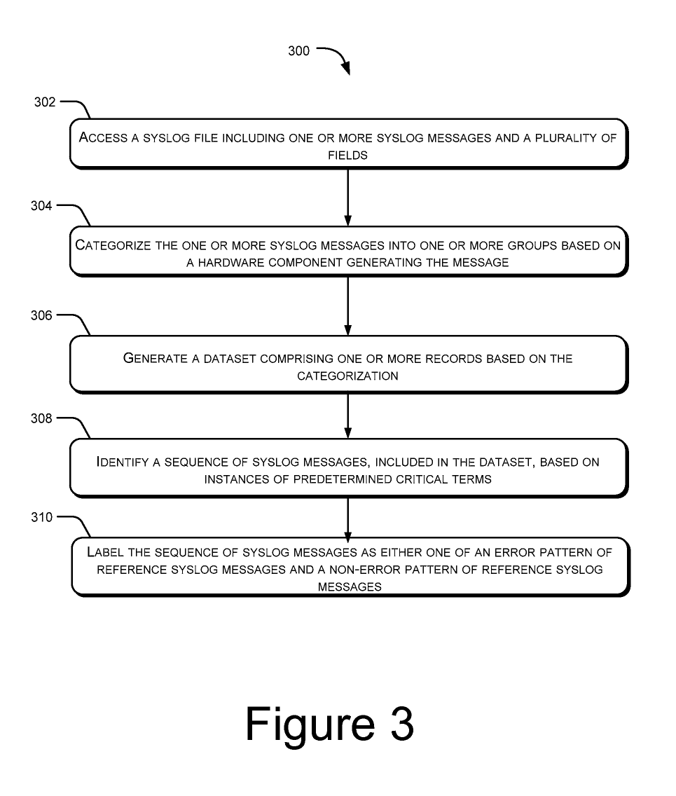

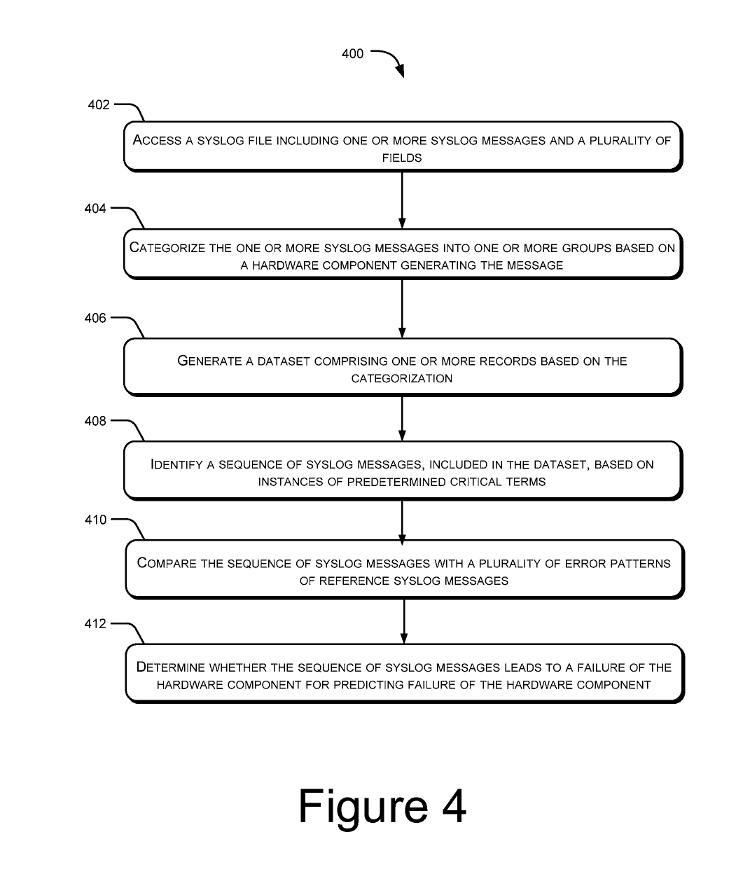

FIG. 3 illustrates a method 300 for generating a training data for predicting failure in hardware components, according to an embodiment of the present subject matter. FIG. 4 illustrates a method 400 for predicting failure in hardware components, according to an embodiment of the present subject matter.

The order in which the methods 300 and 400 are described is not intended to be construed as a limitation, and any number of the described method blocks can be combined in any order to implement methods 300 and 400, or an alternative method. Additionally, individual blocks may be deleted from the methods 300 and 400 without departing from the spirit and scope of the subject matter described herein. Furthermore, the methods 300 and 400 may be implemented in any suitable hardware, machine readable instructions, firmware, or combination thereof.

A person skilled in the art will readily recognize that steps of the methods 300 and 400 can be performed by programmed computers. Herein, some examples are also intended to cover program storage devices and non-transitory computer readable medium, for example, digital data storage media, which are machine or computer readable and encode machine-executable or computer-executable instructions, where said instructions perform some or all of the steps of the described methods 300 and 400. The program storage devices may be, for example, digital memories, magnetic storage media, such as a magnetic disks and magnetic tapes, hard drives, or optically readable digital data storage media.

With reference to FIG. 3, at block 302, a syslog file including one or more syslog messages and a plurality of fields is accessed. The one or more syslog messages included in the syslog file are generated by hardware components, such as processors, boards, servers, and hard disks and may include information pertaining to the operation and tasks performed by such hardware components. The information may be recorded in the plurality of fields of the syslog file. Examples of fields may include, but are not limited to, date and time, component, facility, message type, slot, message, and description. In one implementation, the node 108-1 may access the syslog file stored in the HDFS 106.

At block 304, the one or more syslog messages are categorized into one or more groups based on a hardware component generating the syslog message. Upon obtaining the syslog file, each of the one or more syslog messages is categorized into one or more groups. In one implementation, the syslog messages may be categorized based on the hardware component generating the syslog message. For example, a syslog message generated by a server may be categorized into serverOS group. In one implementation, the node 108-1 may categorize the one or more syslog messages into one or more groups based on a hardware component generating the syslog message.

At block 306, a dataset comprising one or more records is generated based on the categorization. Each of the one or more records of the dataset, interchangeably referred to as training dataset, includes a syslog messages from the one or more syslog messages. In one example, the training dataset may be generated using a folding window technique. In another example, the training dataset may be generated using a sliding window technique. In said example, the training dataset generated may include five records. In one implementation, the node 108-1 may generate the training dataset based on the categorization.

At block 308, a sequence of syslog messages, included in the dataset, is determined. In one example, the dataset may be obtained for generating training data for predicting failure of the hardware components. Initially, critical terms included in the syslog messages are identified. Examples of the predetermined critical terms may include, but are not limited to, alert, warning, error, abort, and failure. Based on the occurrence of the instances of the critical terms, the reference sequence of syslog messages is determined.

At block 310, the sequence of syslog messages are labelled as either one of an error pattern of reference syslog messages and a non-error pattern of reference syslog messages. In one example, it is ascertained whether the reference sequence of syslog messages has led to a failure of the hardware component in the past or not. In one implementation, the ascertaining may be done based on predetermined error data. The predetermined error data may be understood as data including information pertaining to past events of failure of the hardware components. In one example, the predetermined error data sequence pertaining to past events of failure may be stored in a parallel processing database, such as a Greenplum® MPP database. In another implementation, a user, such as an administrator or an expert may perform the ascertaining. Thereafter, the sequence of messages is labelled based on the ascertaining. In a case where the sequence of messages has led to a failure of the hardware component in the past, the sequence of messages is labelled as an error pattern of reference syslog messages. On the other hand, the sequence of messages which did not result in failure of the hardware component may be labelled as a non-error pattern of reference syslog messages. Further, an error resolution data may be associated with each of the identified error pattern of reference syslog messages. The error resolution data may include steps for averting the failure of the hardware component. In one example, the failure prediction device may label the reference sequence of syslog messages.

Further, the error pattern of reference syslog messages and the error resolution data associated with it may be stored in the Greenplum MPP database which may then be used for predicting failure of the hardware components.

With reference to FIG. 4, at block 402, a syslog file including one or more syslog messages and a plurality of fields is accessed. The one or more syslog messages included in the syslog file are generated by hardware components, such as processors, boards, servers, and hard disks and may include information pertaining to the operation and tasks performed by such hardware components. The information may be recorded in the plurality of fields of the syslog file. Examples of fields may include, but are not limited to, date and time, component, facility, message type, slot, message, and description. In one implementation, the node 108-1 may obtain the syslog file stored in the HDFS 106.

At block 404, the one or more syslog messages are categorized into one or more groups based on a hardware component generating the syslog message. Upon obtaining the syslog file, each of the one or more syslog messages is categorized into one or more groups. In one implementation, the syslog messages may be categorized based on the hardware component generating the syslog message. For example, a syslog message generated by a server may be categorized into serverOS group. In one implementation, the node 108-1 may categorize the one or more syslog messages into one or more groups based on a hardware component generating the syslog message.

At block 406, a dataset comprising one or more records is generated based on the categorization. Each of the one or more records of the dataset includes a syslog messages from the one or more syslog messages. In one example, the dataset may be generated using a folding window technique. In another example, the dataset may be generated using a sliding window technique. In said example, the dataset generated may include five syslog messages in each line of the dataset. In one implementation, the node 108-1 may generate the dataset based on the categorization.

At block 408, a sequence of syslog messages, included in the dataset, is identified. In one example, the dataset may be obtained for generating training data for predicting failure of the hardware components. Initially, the syslog messages are analysed for identifying instances of predetermined critical terms. Examples of the predetermined critical terms may include, but are not limited to, alert, warning, error, abort, and failure. Based on the occurrence of the instances of the predetermined critical terms, the sequence of syslog messages is identified.

At block 410, the sequence of syslog messages is compared with a plurality of error patterns of reference syslog messages. Initially, the plurality of error patterns of reference syslog messages may be obtained from a massive parallel processing database, such as a Greenplum® database. Thereafter, the sequence of syslog messages may be compared with each of the plurality of error patterns of reference syslog messages.

At block 412, it is determined whether the sequence of syslog messages leads to a failure of the hardware component for predicting failure of the hardware component. Based on the comparison, if the sequence of messages matches with at least one error pattern of reference syslog messages, it is determined that the sequence of syslog messages may lead to a failure of the hardware component. Subsequently, an error resolution data associated with the identified at least one pattern of reference syslog messages may be provided to a user, such as an administrator for averting the failure of the hardware component.

Although embodiments for systems and methods for predicting failure of hardware components have been described in language specific to structural features and/or methods, it is to be understood that the invention is not necessarily limited to the specific features or methods described. Rather, the specific features and methods are disclosed as exemplary implementations for predicting failure of hardware components.

I/We claim:

1. A computer implemented method for predicting failure of hardware components, the method comprising:
accessing, by a node, a syslog file stored in a Hadoop Distributed File System (HDFS), wherein the syslog file includes at least one or more syslog messages;
categorizing, by the node, each of the one or more syslog messages into one or more groups based on a hardware component generating the syslog message;
generating, by the node, a current dataset comprising one or more records based on the categorization, wherein each of the one or more records include a syslog message from amongst the one or more syslog messages; and
analysing, by a processor, the current dataset for identifying at least one error pattern of syslog messages, based on a plurality of error patterns of reference syslog messages, for predicting failure of the hardware components.

2. The method as claimed in claim 1, wherein the plurality of error patterns of reference syslog messages is ascertained based on a Parallel Support Vector Machine (PSVM) classification technique.

3. The method as claimed in claim 1, wherein the method further comprises converting each of the one or more syslog messages into a dataset format.

4. The method as claimed in claim 1, wherein each of the one or more syslog messages includes information pertaining to the plurality of fields.

5. The method as claimed in claim 1, wherein the analyzing further comprises:
accessing the current dataset;
identifying at least one sequence of syslog messages based on instances of predetermined critical terms, wherein each of the syslog messages in the at least one sequence of syslog messages include at least one or more of the predetermined critical terms; and
comparing the at least one sequence of syslog messages with the plurality of error pattern of reference syslog messages for identifying the at least one error pattern of reference syslog messages.

6. The method as claimed in claim 5, wherein each of the plurality of error patterns of reference syslog messages is associated with corresponding error resolution data.

7. The method as claimed in claim 6, wherein the method further comprises providing the error resolution data associated with the identified at least one error pattern of reference syslog messages to a user, wherein the error resolution data includes steps for averting the hardware failure.

8. The method as claimed in claim 1, wherein each of the one or more syslog messages include information pertaining to a plurality of fields, wherein the fields are at least one of a date and time, component, facility, message type, slot, message, and description.

9. The method as claimed in claim 1, wherein the method further comprises generating a training dataset for identifying the plurality of error patterns of reference syslog messages.

10. The method as claimed in claim 9, wherein the method further comprises:
accessing, by the node, another syslog file stored in a Hadoop Distributed File System (HDFS), wherein the syslog file includes at least one or more syslog messages;
categorizing, by the node, each of the one or more syslog messages into one or more levels based on a hardware component generating the syslog message;
generating, by the node, the training dataset comprising one or more records, wherein each of the one or more records include a syslog message from amongst the one or more syslog messages;
identifying, by a processor, a sequence of syslog messages, stored in the training dataset, based on instances of predetermined critical terms, wherein each of the syslog messages in the sequence of syslog messages include one or more of the predetermined critical terms;
ascertaining, by the processor, whether the sequence of the syslog messages results in a failure of the hardware components generating the syslog messages based on predetermined error data; and
labelling, by the processor, the sequence of syslog messages as either one of an error pattern of reference syslog messages and a non-error pattern of reference syslog messages based on the ascertaining for obtaining training data for predicting failure of the hardware components.

11. A failure prediction system for predicting failure of hardware components over a cloud computing network, the failure prediction system comprising:
a node for generating a current dataset for predicting failure of hardware components comprising:
a processor; and
a classification module coupled to the processor to,
access a syslog file stored in a Hadoop Distributed File System (HDFS), wherein the syslog file includes at least one or more syslog messages;
categorize each of the one or more syslog messages into one or more levels based on a hardware component generating the syslog message; and
generate the current dataset comprising one or more records, wherein each of the one or more records includes a syslog message from amongst the one or more syslog messages; and
a failure prediction device for predicting the failure of the hardware components comprising:
a processor; and
an analysis module coupled to the processor to, analyse the current dataset for identifying at least one error pattern of syslog messages, based on a plurality of error patterns of reference syslog messages, for predicting failure of the hardware components.

12. The failure prediction system as claimed in claim 11, wherein the analysis module of the failure prediction device further,
identifies at least one sequence of syslog messages based on instances of predetermined critical terms, wherein each of the syslog messages in the sequence of syslog messages include one or more of the predetermined critical terms;
compares the at least one sequence of syslog messages with each of the plurality of error patterns of reference syslog messages for identifying the at least one error pattern of reference syslog messages.

13. The failure prediction system as claimed in claim 11, wherein the failure prediction device further comprises a labelling module coupled to the processor to,
access a training dataset comprising one or more records, wherein each of the one or more records include a syslog message from amongst one or more syslog messages logged in a syslog file;
identify at least one sequence of syslog messages, based on instances of predetermined critical terms, wherein each of the syslog messages in the sequence of syslog messages include one or more of the predetermined critical terms;
ascertain whether the at least one sequence of the syslog messages results in a failure of a hardware component generating the syslog messages based on predetermined error data; and
label the sequence of syslog messages as either one of an error pattern of reference syslog messages and a non-error pattern of reference syslog messages for obtaining training data for predicting failure in hardware components.

14. The failure prediction device as claimed in claim 13, wherein the labelling module further associates, with each of the plurality of error pattern of reference syslog messages, a corresponding error resolution data.

15. A non-transitory computer-readable medium having embodied thereon a computer program for executing a method comprising:
accessing a syslog file stored in a Hadoop Distributed File System (HDFS), wherein the syslog file includes at least one or more syslog messages;
categorizing each of the one or more syslog messages into one or more groups based on a hardware component generating the syslog message;
generating a current dataset comprising one or more records based on the categorization, wherein each of the one or more records include a syslog message from amongst the one or more syslog messages; and
analysing the current dataset for identifying at least one error pattern of syslog messages, based on a plurality of error patterns of reference syslog messages, for predicting failure of the hardware components.

16. The non-transitory computer readable medium as claimed in claim 15, wherein the method further comprises generating a training dataset for identifying the plurality of error patterns of reference syslog messages.

17. The non-transitory computer readable medium as claimed in claim 16, wherein the method further comprises:
accessing, by the node, another syslog file stored in a Hadoop Distributed File System (HDFS), wherein the syslog file includes at least one or more syslog messages;
categorizing, by the node, each of the one or more syslog messages into one or more levels based on a hardware component generating the syslog message;
generating, by the node, the training dataset comprising one or more records, wherein each of the one or more records include a syslog message from amongst the one or more syslog messages;
identifying, by a processor, a sequence of syslog messages, stored in the training dataset, based on instances of predetermined critical terms, wherein each of the syslog messages in the sequence of syslog messages include one or more of the predetermined critical terms;
ascertaining, by the processor, whether the sequence of the syslog messages results in a failure of the hardware components generating the syslog messages based on predetermined error data; and
labelling, by the processor, the sequence of syslog messages as either one of an error pattern of reference syslog messages and a non-error pattern of reference syslog messages based on the ascertaining for obtaining training data for predicting failure of the hardware components.
